(19) United States
(12) Patent Application Publication
(10) Pub. No.: US 2023/0092122 A1
(43) Pub. Date: Mar. 23, 2023

(54) SYSTEM AND METHOD FOR A GLOBAL DIGITAL ELEVATION MODEL

(71) Applicant: Climate Central, Princeton, NJ (US)

(72) Inventors: Scott A. Kulp, Kendall Park, NJ (US); Benjamin H. Strauss, Princeton, NJ (US)

(73) Assignee: Climate Central, Princeton, NJ (US)

(21) Appl. No.: 17/948,639

(22) Filed: Sep. 20, 2022

Related U.S. Application Data
(60) Provisional application No. 63/246,015, filed on Sep. 20, 2021.

(51) Int. Cl. G06N 3/04; G06N 3/08

(52) U.S. Cl. CPC G06N 3/04; G06N 3/08

(57) ABSTRACT

A system and method for creating a digital elevation model, and for reducing vertical bias and/or root mean square error (RMSE) of an elevation dataset may be provided. The system may include one or more processors configured to receive input data, provide the input data to a neural network (NN), and generate a digital elevation model based on the predicted elevations output by the NN. The NN may be configured to include an input layer; a plurality of hidden layers connected to the input layer, the plurality of hidden layers configured to iteratively analyze the input data and learn nonlinear relationships between the input data and actual elevation; and an output layer connected to the plurality of hidden layers, the output layer configured to output a predicted elevation based on the analysis of the input data.

### CROSS-REFERENCE TO RELATED APPLICATIONS

The present application claims priority to 63/246,015, filed Sep. 20, 2021, the entirety of which is incorporated by reference herein.

### TECHNICAL FIELD

The present disclosure is drawn to digital elevation models, and specifically to techniques for improving the accuracy of global digital elevation models.

### BACKGROUND

Accurate elevation data is essential to accurately assess the vulnerability of coastal communities to threats from sea level rise (SLR) and coastal flooding. While a few developed countries, such as the US, Australia, the UK, and others in Europe, have released high-quality elevation data derived from airborne lidar, most of the rest of the world, particularly in developing countries, relies on lower-accuracy global digital elevation models (DEMs) derived from satellite radar. These DEMs suffer from large vertical errors with a positive bias—especially in densely populated areas, where accurate vulnerability statistics are most important, but where satellite radar sensors see building tops as hills and mountains.

In recent years, efforts have been made to improve global elevation models by predicting and reducing their errors, though most attempts have either covered a very small area or only sought to reduce bias in vegetated areas, rather than cities. CoastalDEM v1.1 was the first global-scale DEM that used an artificial neural network to correct errors present in NASA's SRTM. This model was tested against lidar-derived elevation data in the US and Australia, and found it greatly improved vertical bias and RMSE compared to SRTM in both forests and cities. However, as version 1.1 was trained on ground truth data in the US alone, and despite its high performance in Australia, there was less confidence in its accuracy in areas with dissimilar vegetation, architecture, and population density.

Thus, a system and method for improving the accuracy of a global digital elevation model are useful and desirable.

### BRIEF SUMMARY

As disclosed herein, provide a more accurate global DEM, a system for creating a digital elevation model may be provided. The system may include one or more processors configured to perform specific steps. The steps may include receiving input data and providing the input data to a neural network (NN), such as a convolution neural network (CNN). The NN may include an input layer; a plurality of hidden layers connected to the input layer, the plurality of hidden layers configured to iteratively analyze the input data and learn nonlinear relationships between the input data and actual elevation; and an output layer connected to the plurality of hidden layers, the output layer configured to output a predicted elevation based on the analysis of the input data. The processor(s) may be configured to then generate a digital elevation model (e.g., a global DEM) based on the predicted elevation.

In some embodiments, the NN may be configured a specific manner. For example, in some embodiments, the input layer may include at least 10 units corresponding to at least 2,000 values of the input data. In some embodiments, the plurality of hidden layers may include at least a thousand hidden units. In some embodiments, the output layer comprises one unit. In some embodiments, the NN may be trained using data from the NASA ICESat-2 mission as ground truth. In some embodiments, the NN may be configured to predict error corrections for locations represented as pixels on a digital raster graphic on land between a minimum and maximum elevation (such as −10 m to 120 m).

In some embodiments, the input data may include vegetation, architecture, and population density information for a plurality of locations. In some embodiments, the input data may include one or more datasets stored on a database operably coupled to at least one of the one or more processors.

In some embodiments, the one or more processors may be further configured to output a graphical map based on the digital elevation model. In some embodiments, the one or more processors may be further configured to receive user input, and based on the user input, generate the graphical map, where the graphical map shows predicted flood locations, vertical bias of the digital elevation model, or root mean square error (RMSE) of the digital elevation model.

In some embodiments, the system may include a plurality of remote devices, each remote device configured to display a graphical map generated based on user input sent from the remote device.

In some embodiments, a method for generating a DEM may be provided. The method may include providing input data to a convolution neural network (CNN) as disclosed herein, and generating a digital elevation model based on the predicted elevation for one or more geographic locations. In some embodiments, the method may include generating a graphical map based on the digital elevation model.

In some embodiments, a method for reducing vertical bias and/or root mean square error (RMSE) of an elevation dataset may be provided. The method may include providing input data to a convolution neural network (NN) as disclosed herein, such as a CNN, and storing the predicted elevation.

### BRIEF DESCRIPTION OF DRAWINGS

FIG. 1 is a block diagram showing an embodiment of a system.

FIG. 2 is a simplified flowchart showing an embodiment of a method.

FIG. 3 is a table showing, as part of a validation effort, global error statistics across each DEM, three elevation thresholds (5 m, 10 m, and 20 m), and three population density bands (any density (Any), more than 1,000 people per km² (>1K), and more than 10,000 people per km² (>10K)). ICESat-2 is used as ground truth. For each row, only pixels are included whose elevation falls below the elevation threshold (according to ground truth or the DEM), and whose population density falls within the given band. Rows presenting CoastalDEM v2.1 statistics are in bold. All units are in meters except for population density, which is people per km².

FIG. 4 is a choropleth map presenting median bias under CoastalDEM v2.1 in low-elevation regions across coastal nations, using ICESat-2 as ground truth. Only grid cells with elevation <5 m and population density >1000 people per km² are considered, and only nations with n≥1000 of these grid cells are evaluated.

FIG. 5 is a choropleth map presenting RMSE under CoastalDEM v2.1 in low-elevation regions across coastal nations, using ICESat-2 as ground truth. Only grid cells with elevation <5 m and population density >1000 people per km² are considered, and only nations with n≥1000 of these grid cells are evaluated.

FIGS. 6A and 6B are density plots of median bias (6A) and RMSE (6B) for each of the global DEMs across level-1 administrative units (GADM 2.0), using ICESat-2 as ground truth. Only grid cells whose elevations are lower than 5 m and contain >1000 people per square km are considered.

FIG. 7 is a table showing error statistics in the USA and Australia across each DEM and three elevation thresholds (5 m, 10 m, and 20 m). Airborne lidar-derived elevation data are used as ground truth. For each row, only pixels are included whose elevation falls below the elevation threshold (according to ground truth or the DEM), and whose population density exceeds 1K per square kilometer. Rows presenting CoastalDEM v2.1 statistics are in bold. All units are in meters.

### DETAILED DESCRIPTION

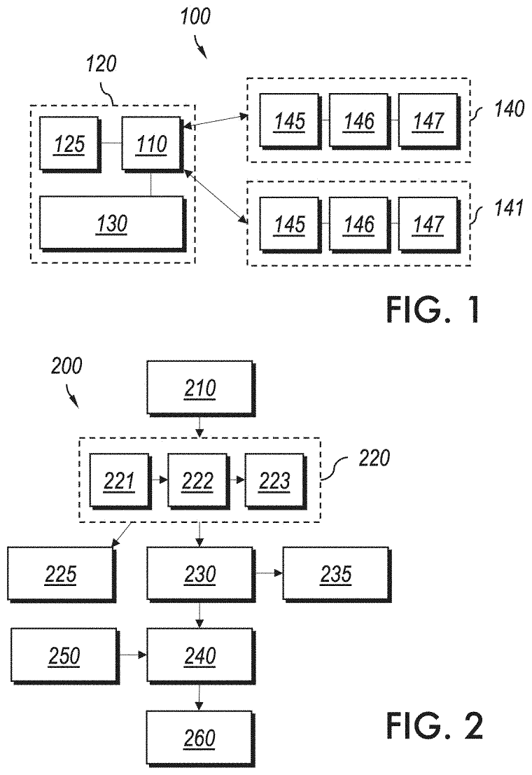

To provide a more accurate global DEM, a system for creating a digital elevation model may be provided. Referring to FIG. 1, in some embodiments, a system 100 may include one or more processors 110. In some embodiments, the one or more processors may be located on a remote server 120. In some embodiments, the one or more processors may be operably coupled to, e.g., memory 125 and/or a non-transitory computer readable medium, which may include a database 130.

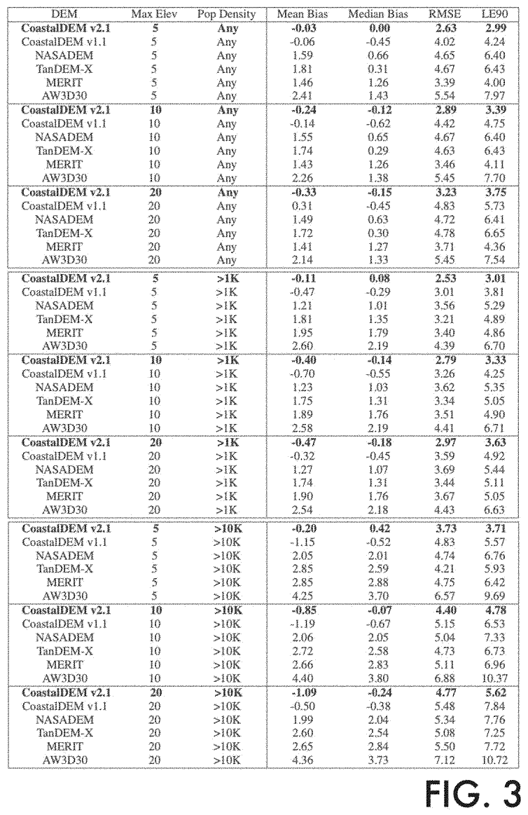

In some embodiments, the non-transitory computer readable medium may contain instructions that, when executed, configure the one or more processors in specific ways. In some embodiments, the specific steps can be understood with respect to FIG. 2. In some embodiments, the computer-based steps or method 200 may include receiving 210 input data.

In some embodiments, the input data may include known elevation data for a plurality of locations, and/or height metrics. In some embodiments, the input data may include vegetation density, architecture, and population density information for a plurality of locations. In some embodiments, the input data may include one or more datasets received from a database (e.g., database 130) operably coupled to at least one of the one or more processors.

The input data is provided 220 to a neural network (NN). The NN may be, e.g., a convolution neural network (CNN). The NN may include an input layer; a plurality of hidden layers connected to the input layer, and an output layer connected to the plurality of hidden layers.

The input layer is configured to receive 221 the input data. The plurality of hidden layers are configured to iteratively analyze 222 the input data and learn nonlinear relationships between the input data and actual elevation. In some embodiments, the plurality of hidden layers is configured to iteratively analyze the input data by adjusting weights between the hidden layers to minimize a difference between the predicted vertical error and an actual vertical error. In some embodiments, the weights between the hidden layers are adjusted based on a training set of known vertical error. In some embodiments, adjusting the weights between the hidden layers is halted based on a validation set of known vertical error.

In some embodiments, the output layer is configured 223 to output a predicted elevation based on the analysis of the input data.

In some embodiments, the NN may be configured a specific manner. For example, in some embodiments, the input layer may include at least 10 units corresponding to at least 2,000 values of the input data. In some embodiments, the plurality of hidden layers may include at least a thousand hidden units. In some embodiments, the output layer comprises or consists of one unit.

The NN may be trained based on available data. Ideally, an error-correcting model would use high-quality globally-available ground truth data to train the model. However, for years, the best available candidate global dataset was ICESat, which was a 2003-2010 NASA satellite mission that, among other objectives, collected elevation profile measurements at points along straight lines across Earth's surface using a single laser altimeter beam (satellite lidar). These points had a large footprint (70 m) and were about 170 m apart along the linear tracks. These data were also noisy, suffering from a multi-meter positive bias in certain terrain types, including forests. While useful to help validate global elevation models, the data from the first ICESat mission were not ideal for use in training a neural network for predicting elevations globally.

In late 2018, NASA launched the ICESat-2 mission, which promised much more dense and accurate land elevation measurements compared to its predecessor. Specifically, ICESat-2 features 6 beams (in 3 pairs, spaced 3 km apart) and gives elevation values every 100 m along track (each value is based on an algorithmic assessment of multiple photon measurements within each 100 m segment). Additionally, ICESat-2 computes vegetation height at every point, largely reducing this source of error, though no such correction is performed for urban structures.

In some embodiments, the NN may be trained using data from the NASA ICESat-2 mission as ground truth.

In some embodiments, an image (such as an image of a map) showing a target location may be divided into pixels, and the NN may be configured to predict error corrections for the pixels. The predicted error corrections can be used to adjust elevation estimates present in the input data for that location. The NN can thus be used to generate predicted elevations globally, or a portion of the globe. For example, in some embodiments, the NN may be configured to predict error corrections for the pixels on land between a minimum and maximum elevation (such as −10 m to 120 m).

The one or more processors may be configured to then generate 230 a digital elevation model (e.g., a global DEM) based on the predicted elevations.

In some embodiments, the one or more processors may be configured to store 235 the digital elevation model (e.g., on a non-transitory computer-readable storage medium, such as database 130).

In some embodiments, the one or more processors may be further configured to output 240 a graphical map based on the digital elevation model. For example, in some embodiments, the one or more processors may be configured to output a color-coded graphical map of a coastal region, a city, a state, a country, or the globe indicating estimated elevations.

Referring to FIG. 1, in some embodiments, the system 100 may include one or more remote devices in communication with the one or more processors. Such remote devices may include desktop or laptop computers, smartphones, tablets, etc. A first device 140 and a second device 141 may each include a processor 145, a display 146, and/or an input device 147 (keyboard, mouse, etc.). The first device may be used by a first user and the second device used by a second user.

Referring to FIGS. 1 and 2, in some embodiments, the one or more processors 110 may be configured to receive 250 user input from a remote device, and based on the user input, generate the graphical map for that user. In some embodiments, the graphical map may show predicted flood locations, vertical bias of the digital elevation model, or root mean square error (RMSE) of the digital elevation model.

In some embodiments, each remote device may be configured to display 260 a graphical map generated by the one or more processors, based on user input sent from that remote device.

In some embodiments, a method for generating a DEM may be provided. As disclosed herein, the method 200 may include providing 220 input data to a convolution neural network (CNN) as disclosed herein, and generating 230 a digital elevation model based on the predicted elevation for one or more geographic locations. In some embodiments, the method may include generating 240 a graphical map based on the digital elevation model.

In some embodiments, a method for reducing vertical bias and/or root mean square error (RMSE) of an elevation dataset may be provided. As disclosed herein, and referring to FIG. 2, the method 200 may include providing 220 input data to a neural network (NN), the NN as disclosed herein, and storing 225 the predicted elevation. The predicted elevations may be stored on, e.g., a non-transitory computer-readable storage medium, such as database 130.

An earlier version of this technique is described in US 2020/00019856 A1, the entirety of which is incorporated by reference herein.

### Example

The system utilized multiple datasets, including NASADEM, WorldPop, and more. While a previous version used NASA's SRTM v 3.0 as input data, that data had errors, with a >2 m positive bias and >4 m RMSE. In this example, NASA's recently-released NASADEM dataset was used, providing a more accurate reprocessing of SRTM's source data. The example was configured to consider pixels whose SRTM elevation lies between −10 m and 120 m, which was aimed at improving results both in low, flat regions with areas of negative vertical error due to random noise, as well as locations with tall skyscrapers that can cause errors exceeding 20 m.

The NN was configured as a CNN with many thousands of hidden units, which is better suited to learn the highly nonlinear relationships between each of the input variables and the actual elevation. The CNN was trained on high-quality global elevation data, using data from NASA's recent ICESat-2 mission, which covers land across the entire world. This choice was aimed at further improving performance in other countries where architecture and population density can be very different than what exists in the US. The input layer allowed for over a thousand input variables for each pixel, giving the neural network much more context for each location to better improve predictions and reduce errors.

For this example, the entirety of the L3A Land and Vegetation Height Version 3 (ATL08) dataset was downloaded, which contains a number of elevation metrics at points 12 m apart along six beam tracks. For each point, the fields h_te_mean, latitude, longitude, and layer flag were extracted. The variable h_te_mean refers to the mean height returned by photons within the point's footprint, and layer_flag is a binary variable that is 1 if the point is likely covered by snow or clouds (points flagged as such are removed). Elevations are referenced to WGS84, which was converted to EGM96 using NOAA's VDatum tool. NASA distributes ICESat-2 measurements as a large collection of HDFS files. All points in the entire ICESat-2 dataset meeting the given requirements and filters described in this report were used in the assessments.

Results of Validation Against ICESat-2

Here land elevation measurements from NASA's ICESat-2 was used as ground truth to assess the global accuracy of global DEMs. The six most-recently released products were included: the present technique, CoastalDEM v1.1, NASADEM, TanDEM-X, MERIT, and AW3D30.

Each DEM was assessed at their native horizontal resolutions, including CoastalDEM v1.1 at 1 arc-second. All ICESat-2 points flagged as being covered by clouds or snow were disregarded. Additionally, all error values exceeding 50 m are treated as outliers and removed from the assessment (fewer than 0.005% of points have a discrepancy this large).

Empirically, it has been found that DEM performance varies by elevation. Since a major focus of the presently disclosed technique is for coastal flood modeling on land presently above sea level especially in populated areas, this example primarily focused on land between 0-5 m relative to the EGM96 geoid (spanning the range of most storm and projected sea-level rise scenarios through the year 2100), and where population density exceeds 1,000 people per square kilometer. More specifically, when assessing vertical accuracy of a DEM, only grid cells where the “true” (ICESat-2) or the “estimated” (DEM) elevations are greater than zero and lower than the given maximum elevation (most often, 5 m) were considered.

For brevity, for the rest of this example, only the upper elevation bounds assessed (<5 m, <10 m, or <20 m) will be listed, with the lower bound of 0 m left implied. All available data points present in ICESat-2 that meet the above requirements and given filters are used in the following assessments.

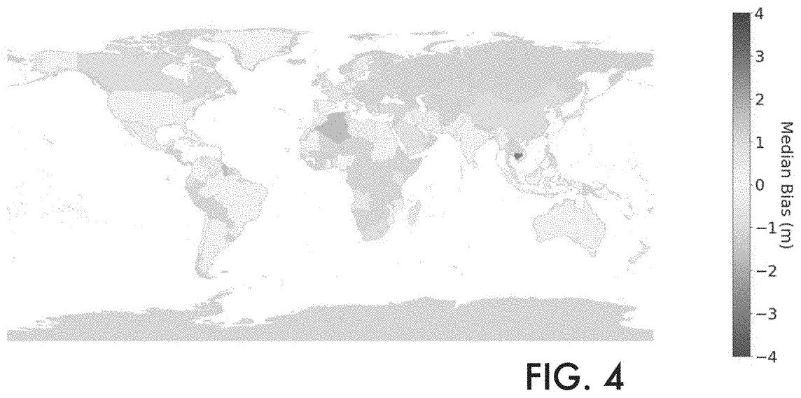

In the whole of the <5 m elevation band (including all areas, regardless of population density), the 30 m version of the present technique (sometimes referred to herein as “CoastalDEM 2.1”) virtually eliminates global median bias to less than 0.01 m, contains an RMSE of 2.63 m, and LE90 (90th percentile linear error) of 2.99 m (see FIG. 3), and outperforms the other global DEMs by a considerable margin. CoastalDEM v1.1 is found to contain errors with a slight negative bias. The present technique corrects that observed bias, while also reducing RMSE/LE90 by 20-50% compared to its competitors. CoastalDEM v2.1 thus shows the highest global accuracy when evaluated with these criteria.

In coastal areas with at least moderate development (greater than 1,000 people per square kilometer, where roughly half of the world's total population lives) and in the elevation range at greatest risk from tides, storms and sea level rise (<5 m), mean vertical bias improves by more than 80%, from −0.5 m with CoastalDEM v1.1 to −0.1 m with CoastalDEM v2.1. These results reflect bias reductions from 91-95% compared to the other comparable DEMs, while maintaining RMSE/LE90 improvements of 20-40%. In segments of coastline with very high population density (greater than 10,000 people per square km, where errors caused by tall buildings are most severe) and the same elevation range (<5 m), CoastalDEM v2.1 contains a slightly positive bias, though still outperforms CoastalDEM v1.1 by 20%, and other DEMs by 80%.

At higher elevations (<20 m), CoastalDEM v2.1 contains slightly elevated errors, with a negative bias at about −0.2 m across all population densities. However, even here, CoastalDEM v2.1's median bias, RMSE, and LE90 outperform each of the other global DEMs. Across the board, performance at <10 m falls between the <5 m and <20 m results.

DEMs can contain spatially-autocorrelated errors even when they exhibit strong global performance, so it is important to also assess bias and RMSE at smaller spatial scales. Here the GADM 2.0 dataset, a collection of global administrative units, was employed to assess error distributions across regions. These distributions are computed at the smallest-available units by binning error values between −50 m to +50 m at 0.01 m intervals, which are added and aggregated to estimate error distributions at wider spatial scales, including across countries. These binned distributions were used to estimate all relevant error metrics, including the median and LE90.

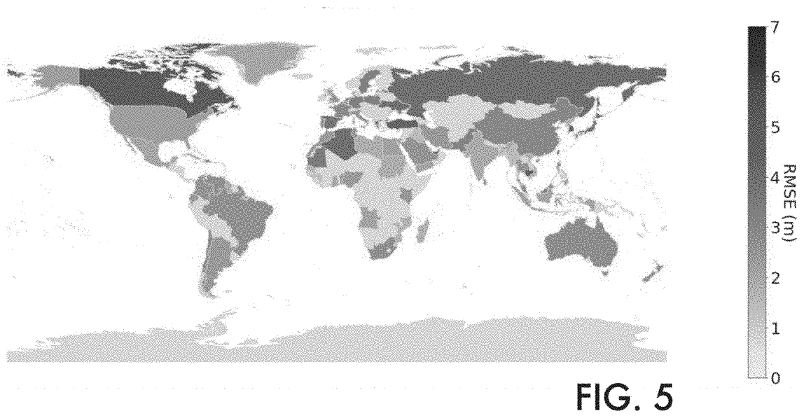

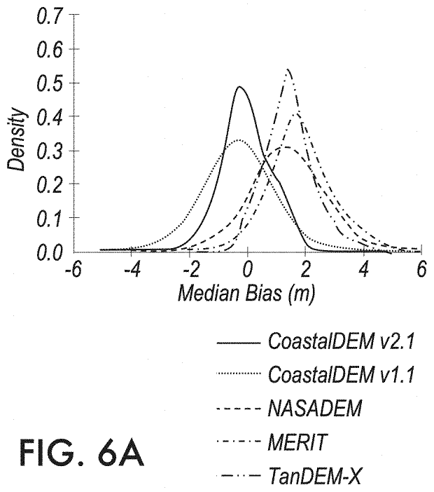

Importantly for more local applications, the performance of the presently disclosed technique is strong across most nations. In FIGS. 4 and 5, choropleth maps of nations' median biases and RMSE's under CoastalDEM v2.1 can be seen. Similar maps were also created for the other DEMs. In this example, these maps only consider areas with at least moderate population density (more than 1,000 people per square kilometer) and below 5 m elevation. Only countries with at least 1,000 pixels meeting these requirements (n≥1000) are shaded. Under these metrics, CoastalDEM v2.1 consistently outperforms other global DEMs, with median bias lower in 90% of countries, and RMSE lower in at least 78% of countries. This is particularly notable in Asia and South America, which contain large populations near the coastline, and in many cases do not have lidar-derived elevation models available.

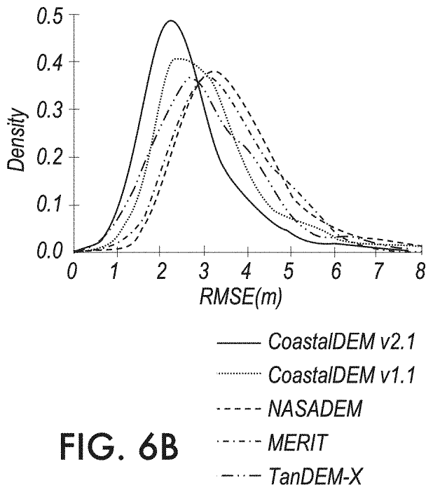

FIGS. 6A and 6B provide further evidence of consistent performance across small spatial scales. Here error was assessed across smaller (‘level 1”) administrative units, roughly equivalent to US counties. We applied the same domain filtering as the preceding figures (>1,000 people per square kilometer, <5 m elevation). This figure presents median bias and RMSE density plots based on all (roughly 1,000 in count) of these small regions. Results for each of the global DEMs are represented by the colored curves, with steeper curves closer to 0 m corresponding to more consistent and accurate results. Again we find CoastalDEM v2.1 outperforms each of the competing DEMs, especially in terms of median bias.

Elevation profiles were generated for select cities comparing ICESat-2, CoastalDEM v2.1, TanDEM-X, and MERIT. Such profiled indicated more clearly that ICESat-2 is an imperfect truth set, especially in such densely populated areas—there are substantial noise and “spikes” in these measurements that can exceed tens of meters. That said, CoastalDEM v2.1's profiles generally did a better job than the other DEMs in following ICESat-2's curves. In fact, CoastalDEM appears to generate an even smoother elevation profile than ICESat-2. CoastalDEM v2.1's increasingly negative computed bias at higher population densities may not reflect true bias, but rather may be explained at least in part by the possibility that ICESat-2 has increasingly positive bias with density.

Validation Against Airborne Lidar-Derived DEMs

While ICESat-2 is the best global elevation data source presently available, the fact that the CNN for the current example was trained using it as ground truth means there is a risk misstating accuracy if ICESat-2 is the only validation. For instance, systematic errors present in ICESat-2 measurements could potentially have been learned by the neural network and propagated across the output dataset. Further, while all available and applicable ICESat-2 measurements were used to assess the DEMs, a small fraction (under 20%) of them was also used to train the CNN model, potentially skewing the results. Finally, since the results above suggest that ICESat-2 itself contains significant error in densely-populated areas, one can seek further validation to better understand CoastalDEM v2.1's performance in such regions. To resolve these concerns, one can use two high-accuracy elevation DEMs derived from airborne lidar as ground truth in the error assessments.

In the United States, NOAA makes publicly available high-quality DEMs across the entire US coastline, which are classified to bare earth elevation, with vertical errors <20 cm RMSE. These data are released at about 5 m horizontal resolution. Here, such data was downsampled to 1 arc-second (about 30 m) using median filtering. Meanwhile, in Australia, Geospace Australia collected and publicly released bare-earth lidar-derived elevation data along much of their coastlines. These data offer <16 cm vertical RMSE at roughly 25 m horizontal resolution, which again, here was downsampled to 1-arcsecond to match an embodiment of CoastalDEM v2.1.

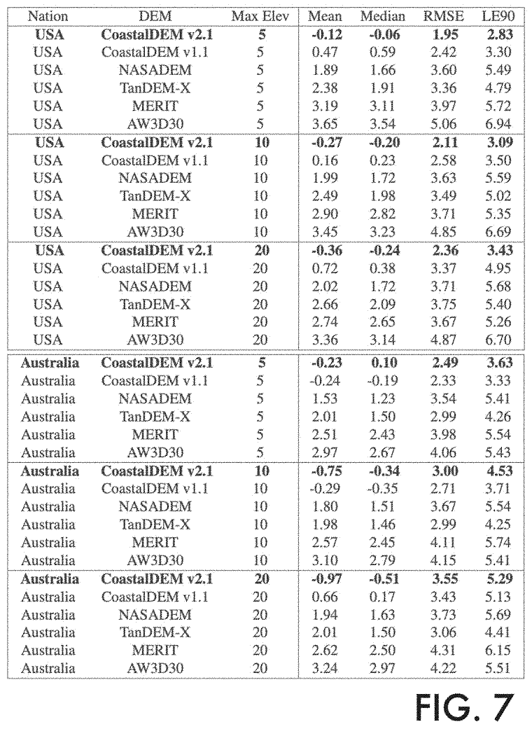

National results for both the US and Australia are presented in FIG. 7. For this example, the focus was on grid cells with population densities exceeding 1,000 per square kilometer. One can again see that CoastalDEM v2.1 exhibits median bias substantially closer to zero than each competing global DEM, and lower RMSE/LE90 values in the elevation band <5 m. CoastalDEM v2.1 even outperforms CoastalDEM v1.1 in the US, which is particularly notable, as the latter was specifically trained using NOAA's lidar-based US coastal DEMs as ground truth.

Error maps were then generated for select cities in the US and Australia. CoastalDEM v2.1 performed strongly relative to the other DEMs overall. Of special note is a region around Miami, Fla.—possibly due to dense development and vegetation, multi-meter biases are present in all past global DEM's across most of south Florida. CoastalDEM v2.1 is the first to have brought down and flattened errors here, without appearing to compromise accuracy in other areas of the US.

Finally, US state-level choropleths of median bias and RMSE for each global DEM were generated. Considering points below 5 m and with >1,000 people per square kilometer, it was found that CoastalDEM v2.1 median bias outperforms the competing global DEMs in all but three states (Maine, Rhode Island, and Pennsylvania).

These error statistics derived from DEMs based on airborne lidar are overall similar to the global results using data based on ICESat-2 satellite lidar. The airborne lidar ground-truth values were not used in computing CoastalDEM v2.1. The consistency in error assessment across testing approaches mitigates concerns about potential overfitting of our neural network model.

Thus, it can be seen that the present system and method can generate DEMs that provide an improved, widely available, near-global digital elevation model for the primary purpose of evaluating coastal flood risk considering storms and sea level rise. With this use case in mind, elevations below 5 m are of particular interest as they span the range of most tides, storms, and projected sea-level-rise scenarios through the year 2100.

In addition, coastal areas with high population density are both areas where accurate vulnerability assessments are especially important and areas where the urbanized, built environment has challenged remote sensing technologies intended to measure ground elevations, resulting in material vertical bias that negatively impacts coastal flood risk assessments. Reducing vertical bias was an objective of the presently disclosed approach, as well as reducing error scatter, measured by RMSE and LE90.

Performance data indicate vertical bias and error scatter are consistently and substantially reduced with DEMs created using the presently disclosed approach. CoastalDEM v2.1 is particularly strong in the elevation range below 5 m where coastal flood risk is acute and in densely populated regions where buildings and the built environment adversely affect other global DEMs. Near-zero bias means smaller elevation errors propagating into coastal flood analysis so critical to understanding the threat posed by sea level rise, storms, and tsunamis.

As disclosed herein, the neural network (NN) described produces prediction elevation elements, which are assembled as raster datasets called digital elevation models (DEMs). Each assembled dataset of prediction elevation elements (a DEM) may be a replacement for the measured elevation dataset that was input to the NN. Each individual data element in the dataset, each DEM element, can be considered an improved representation of ground elevation at a particular location.

The methods disclosed herein involve the creation of a predicted elevation dataset. Once such datasets are created, each individual data element from the predicted elevation dataset may be used in various applications.

In some embodiments, each data element from the predicted elevation dataset may be compared to a water height or elevation, whether measured or as a result of climate, sea level rise, storm, precipitation, hydrodynamic, or tsunami model(s), to assess (e.g., determine or predict) whether the location is expected to flood or be inundated during the conditions being evaluated. Such assessment techniques are known in the art.

In some embodiments, each data element from the predicted elevation dataset may be compared to a water height or elevation, whether measured or as a result of climate, sea level rise, storm, precipitation, hydrodynamic, or tsunami model(s) to calculate the depth of any flood(s) associated with the conditions being evaluated. Techniques for calculating such depths are known in the art.

In some embodiments, each data element from the predicted elevation dataset may be compared to a water height or elevation, whether measured or as a result of climate, sea level rise, storm, precipitation, hydrodynamic, or tsunami model(s) to assess (e.g., determine or predict) if the ground on which an installed infrastructure or environment or a planned infrastructure or environment is expected to flood or be inundated with water during the conditions being evaluated.

In some embodiments, such installed infrastructure or environment or planned infrastructure or environment may include or be directed towards infrastructure or environments for populations of people.

In some embodiments, such installed infrastructure or environment or planned infrastructure or environment may include or be directed towards geographic areas. Such geographic areas may be targeted to specific cities, counties, zipcodes, congressional districts, and/or administrative boundaries. Such geographic areas may be targeted to specific lands, such as private property or public lands. Such geographic areas may be targeted to areas or land with specific uses, such as farmland. Such geographic areas may be targeted to specific zoned areas (e.g., residential zones, commercial zones, and/or industrial zones).

In some embodiments, such geographic areas may include or be directed towards enters of economic activity.

In some embodiments, such installed infrastructure or environment or planned infrastructure or environment may include or be directed towards buildings. Non-limiting examples of such buildings include homes, apartments, hotels, government buildings, houses of worship, schools, colleges, universities, seminaries, medical facilities, hospitals, public safety facilities, colleges and universities, museums, libraries, theaters, businesses, offices, police stations, fire stations, and music and arts buildings.

In some embodiments, such installed infrastructure or environment or planned infrastructure or environment may include or be directed towards transportation infrastructure. Non-limiting examples of such transportation infrastructure include roads, railroads, ports, warehouses, intermodal freight terminals, bridges, parking areas, underpasses, pipelines, tank farms, airports, airport runways, taxiways, hangers, heliports, fueling stations, and charging stations

In some embodiments, such installed infrastructure or environment or planned infrastructure or environment may include or be directed towards communications infrastructure. Non-limiting examples of such communications infrastructure may include telecommunications switches, internet access points, antennae, and cellular sites.

In some embodiments, such installed infrastructure or environment or planned infrastructure or environment may include or be directed towards energy infrastructure. Non-limiting examples of such energy infrastructure may include wells, gathering stations, power plants, transmission lines, transformer stations, terminals, nuclear power plants, and nuclear fuel storage sites.

In some embodiments, such installed infrastructure or environment or planned infrastructure or environment may include or be directed towards hazardous sites. Non-limiting examples of such hazardous sites may include EPA listed sites, hazardous waste sites, RADINFO sites, wastewater sites, superfund sites, sewage plants, and retention ponds.

In some embodiments, such installed infrastructure or environment or planned infrastructure or environment may include or be directed towards areas related to military uses and/or national defense uses. In some embodiments, such installed or planned infrastructure and built environments may include ground-to-space launch sites.

The results of the assessments may then be used in different ways. For example, in some embodiments, the assessments may be used to determine an appropriate insurance rate. In some embodiments, the assessments may be used to determine whether the location is an appropriate location to build a planned building, etc. In some embodiments, the assessments may be used to determine if planned or design elevations for buildings or infrastructure are of sufficient height so as to minimize or avoid damage in the case the location experiences conditions under which the assessments were made. In some embodiments, the assessments may be used to determine whether modifications to an environment or building are needed to prevent damage in the case the location experiences conditions under which the assessments were made.

Those skilled in the art will recognize or be able to ascertain using no more than routine experimentation many equivalents to the specific embodiments of the invention described herein. Such equivalents are intended to be encompassed by the following claims.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for creating a digital elevation model, comprising:
one or more processors configured to:
receive input data;
provide the input data to a neural network (NN), the NN comprising:
an input layer;
a plurality of hidden layers connected to the input layer, the plurality of hidden layers configured to iteratively analyze the input data and learn nonlinear relationships between the input data and actual elevation; and
an output layer connected to the plurality of hidden layers, the output layer configured to output a predicted elevation based on the analysis of the input data; and
generate a digital elevation model based on the predicted elevation.

2. The system according to claim 1, wherein input data includes vegetation, architecture, and population density information for a plurality of locations.

3. The system according to claim 1, wherein the plurality of hidden layers comprises at least a thousand hidden units.

4. The system according to claim 1, wherein the input layer comprises at least 10 units corresponding to at least 2,000 values of the input data.

5. The system according to claim 1, wherein the output layer comprises one unit.

6. The system according to claim 1, wherein the NN is trained using data from a NASA ICESat-2 mission as ground truth.

7. The system according to claim 1, wherein the NN is configured to predict error corrections for pixels on land between a minimum and maximum elevation.

8. The system according to claim 6, wherein the minimum elevation is −10 m, and the maximum elevation is 120 m.

9. The system according to claim 1, wherein the input data comprises one or more datasets stored on a database operably coupled to at least one of the one or more processors.

10. The system according to claim 1, wherein the one or more processors is further configured to output a graphical map based on the digital elevation model.

11. The system according to claim 9, wherein the one or more processors is further configured to receive user input, and based on the user input, generate the graphical map, where the graphical map shows predicted flood locations, vertical bias of the digital elevation model, or root mean square error (RMSE) of the digital elevation model.

12. The system according to claim 10, further comprising a plurality of remote devices, each remote device configured to display a graphical map generated based on user input sent from the remote device.

13. The system according to claim 1, wherein the NN is a convolution neural network (CNN).

14. The system according to claim 1, wherein the one or more processors are further configured to:
compare each data element of the digital elevation model to a water height or elevation; and
for each data element,
assess whether a location represented by the data element is at or below an elevation expected to flood or be inundated based on the water height or elevation;
assess whether ground on which an installed infrastructure or environment or planned infrastructure or environment at a location represented by the data element is at or below an elevation expected to flood or be inundated based on the water height or elevation; and/or
calculate a depth of a flood at a location represented by the data element based on the water height or elevation whether such water height or elevation is the result of a measurement, prediction, or flood model.

15. A method for creating a digital elevation model, comprising:
providing input data to a neural network (NN), the NN comprising:
an input layer;
a plurality of hidden layers connected to the input layer, the plurality of hidden layers configured to iteratively analyze the input data and learn nonlinear relationships between the input data and actual elevation; and
an output layer connected to the plurality of hidden layers, the output layer configured to output a predicted elevation based on the analysis of the input data; and
generating a digital elevation model based on the predicted elevation for one or more geographic locations.

16. The method according to claim 15, further comprising generating a graphical map based on the digital elevation model.

17. The method according to claim 15, wherein input data includes vegetation, architecture, and population density information for a plurality of locations.

18. The method according to claim 15, wherein the plurality of hidden layers comprises at least a thousand hidden units.

19. The method according to claim 15, wherein the input layer comprises at least 10 units corresponding to at least 2,000 values of the input data.

20. The method according to claim 15, wherein the output layer comprises one unit.

21. The method according to claim 15, wherein the NN is trained using data from a NASA ICESat-2 mission as ground truth.

22. The method according to claim 15, wherein the NN is configured to predict error corrections for pixels on land between a minimum and maximum elevation.

23. The method according to claim 22, wherein the minimum elevation is −10 m, and the maximum elevation is 120 m.

24. The method according to claim 15, wherein the input data comprises one or more datasets stored on a database operably coupled to at least one of the one or more processors.

25. The method according to claim 15, further comprising outputting a graphical map based on the digital elevation model.

26. The method according to claim 25, further comprising receiving user input, and based on the user input, generating the graphical map, where the graphical map shows predicted flood locations, predicted flood depth at each predicted flood location, vertical bias of the digital elevation model, or root mean square error (RMSE) of the digital elevation model.

27. The method according to claim 15, wherein the NN is a convolution neural network (CNN).

28. The method according to claim 15, further comprising:
comparing each data element of the digital elevation model to a water height or elevation; and
for each data element,
assessing whether a location represented by the data element is expected to flood or be inundated based on the water height or elevation;
assessing whether ground on which an installed infrastructure or environment or planned infrastructure or environment at a location represented by the data element is expected to flood or be inundated based on the water height or elevation; and/or
calculating a depth of a flood at a location represented by the data element based on the water height or elevation.

29. A method for reducing vertical bias and/or root mean square error (RMSE) of an elevation dataset, comprising:
providing input data to a convolution neural network (NN), the NN comprising:
an input layer;
a plurality of hidden layers connected to the input layer, the plurality of hidden layers configured to iteratively analyze the input data and learn nonlinear relationships between the input data and actual elevation; and
an output layer connected to the plurality of hidden layers, the output layer configured to output a predicted elevation based on the analysis of the input data; and
storing the predicted elevation.
